(19) United States
(12) Patent Application Publication
(10) Pub. No.: US 2003/0079060 A1
(43) Pub. Date: Apr. 24, 2003

(54) Universal download program for establishing communication with a gate array

(76) Inventor: Andrew Dunlop, Oxford (GB)

Correspondence Address: C. DOUGLAS MCDONALD, CARLTON FIELDS, P.A., P.O. BOX 3239, TAMPA, FL, 33601-3239, US

(21) Appl. No.: 09/825,166

(22) Filed: Apr. 2, 2001

(51) Int. Cl. G06F 13/14

(52) U.S. Cl. 710/5

(57) ABSTRACT

A system, method and article of manufacture are provided for affording communication between a gate array and a host. The process begins with the receipt of a request to execute an operation on a gate array coupled to a host. First, a type of the gate array is identified. Thereafter, it is determined whether the gate array is capable of the operation based on the type thereof. Further, the operation is conditionally executed on the gate array based on the previous step.

### FIELD OF THE INVENTION

The present invention relates to communication protocols and more particularly to providing communication between a host and a gate array.

### BACKGROUND OF THE INVENTION

The Parallel Port is the most commonly used port for interfacing various peripheral devices. This port will allow the input of up to 9 bits or the output of 12 bits at any one given time, thus requiring minimal external circuitry to implement many simpler tasks. The port is composed of 4 control lines, 5 status lines and 8 data lines. It's found commonly on the back of a PC as a D-Type 25 Pin female connector. Newer Parallel Port's are standardized under the IEEE 1284 standard first released in 1994. This standard defines 5 modes of operation which are shown in Table 1.

TABLE 1

1. Compatibility Mode.
2. Nibble Mode. (Protocol not Described in this Document)
3. Byte Mode. (Protocol not Described in this Document)
4. EPP Mode (Enhanced Parallel Port).
5. ECP Mode (Extended Capabilities Mode).

The aim of this multiple-mode design is to provide new drivers and devices which were compatible with each other and also backwards compatible with the Standard Parallel Port (SPP). Compatibility, Nibble & Byte modes use just the standard hardware available on the original Parallel Port cards while EPP & ECP modes require additional hardware which can run at faster speeds, while still being downwards compatible with the Standard Parallel Port.

Compatibility mode or “Centronics Mode” as it is commonly known, can only send data in the forward direction at a typical speed of 50 Kbytes per second but can be as high as 150+ Kbytes a second. In order to receive data, one must change the mode to either Nibble or Byte mode. Nibble mode can input a nibble (4 bits) in the reverse direction, e.g. from device to computer. Byte mode uses the parallel's bi-directional feature (found only on some cards) to input a byte (8 bits) of data in the reverse direction.

Extended and Enhanced Parallel Ports use additional hardware to generate and manage handshaking. To output a byte to a printer (or anything in that matter) using compatibility mode, the software must carry out the operations in Table 2.

TABLE 2

1. Write the byte to the Data Port.
2. Check to see is the printer is busy. If the printer is
busy, it will not accept any data, thus any data which is
written will be lost.
3. Take the Strobe (Pin 1) low. This tells the printer
that there is the correct data on the data lines. (Pins 2-
9)
4. Put the strobe high again after waiting approximately 5
microseconds after putting the strobe low. (Step 3)

This limits the speed at which the port can run. The EPP & ECP ports get around this by letting the hardware check to see if the printer is busy and generate a strobe and/or appropriate handshaking. This means only one I/O instruction need to be performed, s thus increasing the speed. These ports can output at around 1-2 megabytes per second. The ECP port also has the advantage of using DMA channels and FIFO buffers, thus data can be shifted around without using I/O instructions.

Prior art FIG. 1 illustrates a pin out diagram 100 of the D-Type 25 Pin connector and the Centronics 34 Pin connector. Prior art FIG. 1A illustrates the port assignments 150, in accordance with a prior art parallel port. The D-Type 25 pin connector is the most common connector found on the Parallel Port of the computer, while the Centronics Connector is commonly found on printers. The IEEE 1284 standard however specifies 3 different connectors for use with the Parallel Port. The first one, 1284 Type A is the D-Type 25 connector found on the back of most computers. The 2nd is the 1284 Type B which is the 36 pin Centronics Connector found on most printers.

IEEE 1284 Type C, however, is a 36 conductor connector like the Centronics, but smaller. This connector is claimed to have a better clip latch, better electrical properties and is easier to assemble. It also contains two more pins for signals which can be used to see whether the other device connected, has power. 1284 Type C connectors are recommended for new designs.

The output of the Parallel Port is normally TTL logic levels. The voltage levels are the easy part. The current one can sink and source varies from port to port. Most Parallel Ports implemented in ASIC, can sink and source around 12 mA. However these are just some of the figures taken from Data sheets, Sink/Source 6 mA, Source 12mA/Sink 20 mA, Sink 16 mA/Source 4 mA, Sink/Source 12 mA. They vary quite a bit. The best bet is to use a buffer, so the least current is drawn from the Parallel Port.

Centronics is an early standard for transferring data from a host to the printer. The majority of printers use this handshake. This handshake is normally implemented using a Standard Parallel Port under software control. Prior art FIG. 2 illustrates a timing diagram 200 showing the ‘Centronics’ Protocol.

Table 3 illustrates commonly used base addresses of the parallel port.

TABLE 3

| Address | Notes: |
|---|---|
| 3BCh-3BFh | Used for Parallel Ports which were incorporated |
| | on to Video Cards - Doesn't support ECP |
| | addresses |
| 378h-37Fh | Usual Address For LPT 1 |
| 278h-27Fh | Usual Address For LPT 2 |

The 3BCh base address was originally introduced used for Parallel Ports on early video cards. This address then disappeared for a while, when Parallel Ports were later removed from video cards. They has now reappeared as an option for Parallel Ports integrated onto motherboards, upon which their configuration can be changed using BIOS.

LPT1 is normally assigned base address 378 h, while LPT2 is assigned 278 h. However this may not always be the case as explained later. 378 h & 278 h have always been commonly used for Parallel Ports. The lower case h denotes that it is in hexadecimal. These addresses may change from machine to machine.

When the computer is first turned on, BIOS (Basic Input/Output System) will determine the number of ports exist and assign device labels LPT1, LPT2 & LPT3 to them. BIOS first looks at address 3BCh. If a Parallel Port is found here, it is assigned as LPT1, then it searches at location 378 h. If a Parallel card is found there, it is assigned the next free device label. This would be LPT1 if a card wasn't found at 3BCh or LPT2 if a card was found at 3BCh. The last port of call is 278 h and follows the same procedure than the other two ports. Therefore it is possible to have a LPT2 which is at 378 h and not at the expected address 278 h.

The assigned devices LPT1, LPT2 & LPT3 should not be a worry to people wishing to interface devices to their PC's. Most of the time the base address is used to interface the port rather than LPT1 etc. However should one want to find the address of LPT1 or any of the Line PrinTer Devices, one can use a lookup table provided by BIOS. When BIOS assigns addresses to printer devices, it stores the address at specific locations in memory, so one can find them. Table 4 illustrates LPT Addresses in the BIOS Data Area.

TABLE 4

| Start Address | Function |
|---|---|
| 0000:0408 | LPT1's Base Address |
| 0000:040A | LPT2's Base Address |
| 0000:040C | LPT3's Base Address |
| 0000:040E | LPT4's Base Address (Note 1) |

The above table shows the address at which one can find the Printe Port's addresses in the BIOS Data Area. Each address will take up 2 bytes. Table 5 illustrates sample program in C, and shows how one can read these locations to obtain the addresses of printer ports.

TABLE 5

#include <stdio.h>
#include <dos.h>
void main (void)
{

unsigned int far *ptraddr; /* Pointer to

location of Port Addresses */

unsigned int address; /* Address of Port

*/

int a;
ptraddr=(unsigned int far *) 0x00000408;
for (a = 0; a < 3; a++)

{

address = *ptraddr;
if (address == 0)

printf (“No port found for LPT%d

\n”, a+1);

else

printf (“Address assigned to LPT%d is

%Xh\n”, a+1, address);

*ptraddr++;

}

}

The base address, usually called the Data Port or Data Register is simply used for outputting data on the Parallel Port's data lines (Pins 2-9). This register is normally a write only port. If one reads from the port, he or she should get the last byte sent. However if the port is bidirectional, one can receive data on this address. Table 6 illustrates the various properties of a Data Port.

TABLE 6

| Offset | Name | Read/Write | Bit No. | Properties |
|---|---|---|---|---|
| Base + 0 | Data | Write | Bit 7 | Data 7 |
| | Port | (Note-1) | Bit 6 | Data 6 |
| | | | Bit 5 | Data 5 |
| | | | Bit 4 | Data 4 |
| | | | Bit 3 | Data 3 |
| | | | Bit 2 | Data 2 |
| | | | Bit 1 | Data 1 |
| | | | Bit 0 | Data 0 |

The Status Port (base address +1) is a read only port. Any data written to this port will be ignored. The Status Port is made up of 5 input lines (Pins 10, 11, 12, 13 & 15), a IRQ status register and two reserved bits. Please note that Bit 7 (Busy) is an active low input. E.g. if bit 7 happens to show a logic 0, this means that there is +5v at pin 11. Likewise with Bit 2. (nIRQ) If this bit shows a ‘1’ then an interrupt has not occurred. Table 7 illustrates the various properties of the Status Port.

TABLE 7

| Offset | Name | Read/Write | Bit No. | Properties |
|---|---|---|---|---|
| Base + 1 | Status | Read Only | Bit 7 | Busy |
| | Port | | Bit 6 | Ack |
| | | | Bit 5 | Paper Out |
| | | | Bit 4 | Select In |
| | | | Bit 3 | Error |
| | | | Bit 2 | IRQ (Not) |
| | | | Bit 1 | Reserved |
| | | | Bit 0 | Reserved |

The Control Port (base address +2) was intended as a write only port. When a printer is attached to the Parallel Port, four “controls” are used. These are Strobe, Auto Linefeed, Initialize and Select Printer, all of which are inverted except Initialize. Table 8 illustrates the various properties of the Control Port.

TABLE 8

| Offset | Name | Read/Write | Bit No. | Properties |
|---|---|---|---|---|
| Base + 2 | Control | Read/Write | Bit 7 | Unused |
| | Port | | Bit 6 | Unused |
| | | | Bit 5 | Enable Bi- |
| | | | | Directional Port |
| | | | Bit 4 | Enable IRQ Via |
| | | | | Ack Line |
| | | | Bit 3 | Select Printer |
| | | | Bit 2 | Initialize Printer |
| | | | | (Reset) |
| | | | Bit 1 | Auto Linefeed |
| | | | Bit 0 | Strobe |

The printer would not send a signal to initialize the computer, nor would it tell the computer to use auto linefeed. However these four outputs can also be used for inputs. If the computer has placed a pin high (e.g. +5v) and a device wanted to take it low, one would effectively short out the port, causing a conflict on that pin. Therefore these lines are “open collector” outputs (or open drain for CMOS devices). This means that it has two states. A low state (0v) and a high impedance state (open circuit). Normally the Printer Card will have internal pull-up resistors, but as one would expect, not all will. Some may just have open collector outputs, while others may even have normal totem pole outputs. In order to make a device works correctly on as many Printer Ports as possible, one can use an external resistor as well. Should one already have an internal resistor, then it will act in Parallel with it, or if Totem pole outputs exist, the resistor will act as a load.

An external 4.7 k resistor can be used to pull the pin high. One wouldn't use anything lower, just in case one does have an internal pull up resistor, as the external resistor would act in parallel giving effectively, a lower value pull up resistor. When in high impedance state, the pin on the Parallel Port is high (+5v). When in this state, an external device can pull the pin low and have the control port change read a different value. This way the 4 pins of the Control Port can be used for bi-directional data transfer. However the Control Port must be set to xxxx0100 to be able to read data, that is all pins to be +5v at the port so that one can pull it down to GND (logic 0). Bits 4 & 5 are internal controls. Bit four will enable the IRQ (See Using the Parallel Ports IRQ) and Bit 5 will enable the bi-directional port meaning that one can input 8 bits using (DATAO-7). This mode is only possible if a card supports it. Bits 6 & 7 are reserved. Any writes to these two bits will be ignored.

Prior art FIG. 3 is schematic diagram showing a simplified view of a data register 300 of a Parallel Port. The original Parallel Port card's implemented 74LS logic. Commonly, all of the foregoing is situated into one ASIC, but the theory of operation is still the same.

The non bi-directional ports were manufactured with the 74LS374's output enable tied permanent low, thus the data port is always output only. When one reads the Parallel Port's data register, the data comes from the 74LS374 which is also connected to the data pins. Now if one can overdrive the '374 he or she can effectively have a Bi-directional Port.

Bi-directional ports use Control Bit 5 connected to the 374's Output Enable so that it's output drivers can be turned off. This way one can read data present on the Parallel Port's Data Pins, without having bus conflicts and excessive current drains.

Bit 5 of the Control Port enables or disables the bi-directional function of the Parallel Port. This is only available on true bi-directional ports. When this bit is set to one, pins 2 to 9 go into high impedance state. Once in this state one can enter data on these lines and retrieve it from the Data Port (base address). Any data which is written to the data port will be stored but will not be available at the data pins. To turn off bi-directional mode, set bit 5 of the Control Port to ‘0’.

However, not all ports behave in the same way. Other ports may require setting bit 6 of the Control Port to enable Bi-directional mode and setting of Bit 5 to dis-enable Bi-directional mode. Different manufacturers implement their bi-directional ports in different ways. If one wishes to use a Bi-directional port to input data, test it with a logic probe or multimeter first to make sure it is in bi-directional mode.

If a Parallel Port doesn't support bidirectional mode, one can input a maximum of 9 bits at any one given time. To do this one can use the 5 input lines of the Status Port and the 4 inputs (open collector) lines of the Control Port. Note Prior Art FIG. 4.

Today, most Parallel Ports are multimode ports. They are normally software configurable to one of many modes from BIOS. Table 8 illustrates the typical modes.

TABLE 8

Printer Mode (Sometimes called Default or Normal Modes)
Standard & Bi-directional (SPP) Mode
EPP1.7 and SPP Mode
EPP1.9 and SPP Mode
ECP Mode
ECP and EPP1.7 Mode
ECP and EPP1.9 Mode

Printer Mode is the most basic mode. It is a Standard Parallel Port in forward mode only. It has no bi-directional feature, thus Bit 5 of the Control Port will not respond.

Standard & Bi-directional (SPP) Mode is the bi-directional mode. Using this mode, bit 5 of the Control Port will reverse the direction of the port, so one can read back a value on the data lines.

EPP1.7 and SPP Mode is a combination of EPP 1.7 (Enhanced Parallel Port) and SPP Modes. In this mode of operation one will have access to the SPP registers (Data, Status and Control) and access to the EPP Registers. In this mode one should be able to reverse the direction of the port using bit 5 of the control register. EPP 1.7 is the earlier version of EPP. This version, version 1.7, may not have the time-out bit.

EPP1.9 and SPP Mode is just like the previous mode, only it uses EPP Version 1.9 this time. As in the other mode, one will have access to the SPP registers, including Bit 5 of the control port. However this differs from EPP1.7 and SPP Mode as one should have access to the EPP Timeout bit.

ECP Mode will give an Extended Capabilities Port. The mode of this port can then be set using the ECP's Extended Control Register (ECR). However in this mode from BIOS the EPP Mode (100) will not be available.

ECP and EPP1.7 Mode and ECP and EPP1.9 Mode will give an Extended Capabilities Port, just like the previous mode. However the EPP Mode in the ECP's ECR will now be available.

The above modes are configurable via BIOS. One can reconfigure them by using his or her software, but this is not recommended. These software registers, typically found at 0×2FA, 0×3F0, 0×3F1 etc are only intended to be accessed by BIOS. There is no set standard for these configuration registers, thus if one were to use these registers, the software would not be very portable. With today's multitasking operating systems, it's also not a good idea to change them when it suits you.

A better option is to select ECP and EPP1.7 Mode or ECP and EPP1.9 Mode from BIOS and then use the ECP's Extended Control Register to select the Parallel Port's Mode. The EPP1.7 mode had a few problems in regards to the Data and Address Strobes being asserted to start a cycle regardless of the wait state, thus this mode if not typically used now. Note Table 9.

TABLE 9

| | |
|---|---|
| Standard Mode | Selecting this mode will cause the ECP port to |
| | behave as a Standard Parallel Port, without bi-directional |
| | functionality. |
| Byte Mode/ | Behaves as a SPP in bi-directional mode. |
| PS/2 Mode | Bit 5 will place the port in reverse mode. |
| Parallel Port | In this mode, any data written to the |
| FIFO Mode | Data FIFO will be sent to the peripheral |
| | using the SPP Handshake. The hardware will generate |
| | the handshaking required. Useful with non-ECP devices |
| | such as Printers. One can have some of the features of |
| | ECP like FIFO buffers and hardware generation of |
| | handshaking but with the existing SPP handshake |
| | instead of the ECP Handshake. |
| ECP FIFO | Standard mode for ECP use. This mode uses the ECP |
| Mode | Handshake described in Interfacing the Extended |
| | Capabilities Port. - When in ECP Mode though BIOS, |
| | and the ECR register is set to ECP FIFO Mode (011), |
| | the SPP registers may disappear. |
| EPP | This will enable EPP Mode, if available. Under BIOS, |
| Mode/Reserved | if ECP mode is set then it's more than likely, |
| | this mode is not an option. However if BIOS is set to |
| | ECP and EPP1.x Mode, then EPP 1.x will be enabled. |
| | - Under Microsoft's Extended Capabilities Port |
| | Protocol and ISA Interface Standard this |
| | mode is Vendor Specified. |
| Reserved | Currently Reserved. - Under Microsoft's Extended |
| | Capabilities Port Protocol and ISA Interface Standard this |
| | mode is Vendor Specified. |
| FIFO Test | While in this mode, any data written to the |
| Mode | Test FIFO Register will be placed into the FIFO |
| | and any data read from the Test FIFO register will be |
| | read from the FIFO buffer. The FIFO Full/Empty Status |
| | Bits will reflect their true value, thus FIFO depth, |
| | among other things can be determined in this mode. |
| Configuration | In this mode, the two configuration registers, cnfgA & |
| Mode | cnfgB become available at their designated |
| | register addresses. |

### SUMMARY OF THE INVENTION

A system, method and article of manufacture are provided for affording communication between a gate array and a host. The process begins with the receipt of a request to execute an operation on a gate array coupled to a host. First, a type of the gate array is identified. Thereafter, it is determined whether the gate array is capable of the operation based on the type thereof. Further, the operation is conditionally executed on the gate array based on the previous step.

In one embodiment of the present invention, the type of the gate array may be identified by receiving an identifier from the gate array. Further, the identifier may be received during an initialization stage. Still yet, the gate array may be programmed utilizing Handel-C.

In another embodiment of the present invention, the step of determining may include comparing parameters corresponding to the operation with capabilities associated with the type of the gate array.

### BRIEF DESCRIPTION OF THE DRAWINGS

The invention will be better understood when consideration is given to the following detailed description thereof. Such description makes reference to the annexed drawings wherein:

FIGS. 1 through 4 illustrate the prior art;

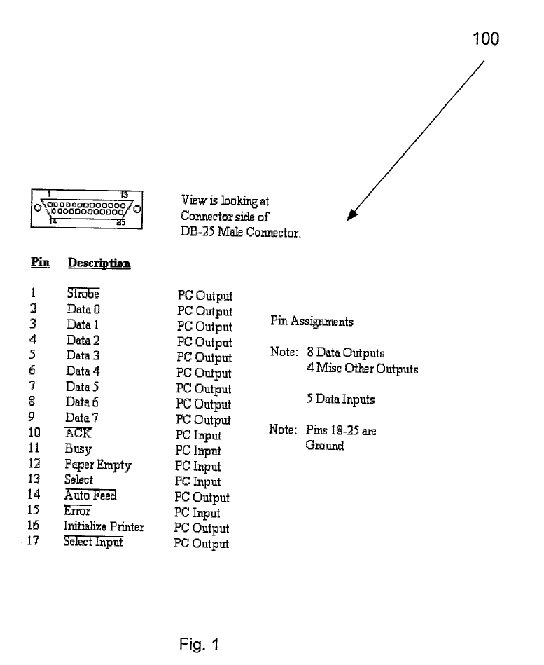

FIG. 5 is a schematic diagram of a hardware implementation of one embodiment of the present invention;

FIG. 6 is a schematic diagram of one embodiment of the present invention where the central processing unit interfaces a gate array via a parallel port;

FIG. 7 illustrates the format of each port, in accordance with one embodiment of the present invention;

FIG. 8 illustrates the signals into which the pins are translated, in accordance with one embodiment of the present invention;

FIG. 9 illustrates a protocol used for each byte sent to the FPGA;

FIG. 9A is a timing diagram illustrating the timing associated with the protocol of FIG. 9;

FIG. 10 shows the protocol associated with the host, in accordance with one embodiment of the present invention;

FIG. 11 is a timing diagram showing the timing associated with the operation of the protocol of FIG. 10;

FIG. 12 illustrates FPGA and Host code, external files, external programs, additional files, macros, and additional functions written in C, in accordance with one embodiment of the present invention;

FIG. 13 illustrates a method for providing communication between a gate array and a host;

FIG. 14 is a flowchart illustrating the method with which the flash block address and a byte of data are sent to flash memory;

FIG. 15 illustrates various options for use as a command options parameter;

FIG. 16 illustrates various options for use as a final name parameter;

FIG. 17 illustrates various options for use as an address options parameter;

FIG. 18 illustrates various options for use as a port parameter;

FIG. 19 illustrates various options for use as the “other” options parameter;

FIG. 20 illustrates a preferred embodiment of a parallel port cable to be used in conjunction with the present invention; and

FIG. 21 illustrates various definitions, external dependencies, and program files associated with the present invention.

### DETAILED DESCRIPTION OF THE PREFERRED EMBODIMENTS

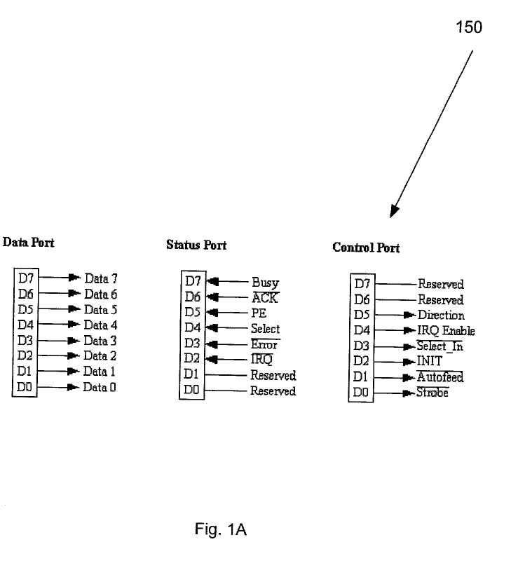

A preferred embodiment of a system in accordance with the present invention is preferably practiced in the context of a personal computer such as an IBM compatible personal computer, Apple Macintosh computer or UNIX based workstation. A representative hardware environment is depicted in FIG. 5, which illustrates a typical hardware configuration of a workstation in accordance with a preferred embodiment having a central processing unit 510, such as a microprocessor, and a number of other units interconnected via a system bus 512. The workstation shown in FIG. 5 includes a Random Access Memory (RAM) 514, Read Only Memory (ROM) 516, an I/O adapter 518 for connecting peripheral devices such as disk storage units 520 to the bus 512, a user interface adapter 522 for connecting a keyboard 524, a mouse 526, a speaker 528, a microphone 532, and/or other user interface devices such as a touch screen (not shown) to the bus 112, communication adapter 534 for connecting the workstation to a communication network (e.g., a data processing network) and a display adapter 536 for connecting the bus 512 to a display device 538. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

In one embodiment, the hardware environment of FIG. 5 may include, at least in part, a field programmable gate array (FPGA) device. For example, the central processing unit 510 may be replaced or supplemented with an FPGA. Use of such device provides flexibility in functionality, while maintaining high processing speeds.

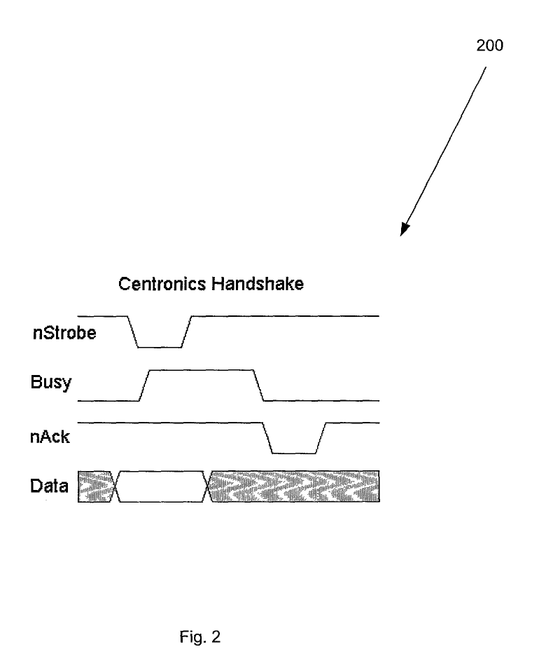

FIG. 6 is a schematic diagram of one embodiment 600 of the present invention where the central processing unit 510 interfaces a gate array 606 via a parallel port 604. As an option, such parallel port 604 may be equipped to interface with a Hammond® board. Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reProgrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's' may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modem FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.TM. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Limited. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Additional information may also be found in a co-pending application entitled “SYSTEM, METHOD AND ARTICLE OF MANUFACTURE FOR PARAMETERIZED EXPRESSION LIBRARIES” which was filed Jan. 29, 2001 under Ser. No. 09/772,671, and which is incorporated herein by reference in its entirety.

The present invention provides a communications protocol between a FPGA (Note FIG. 6) and a host PC (Note FIG. 5). As mentioned earlier, the FPGA may be positioned on a Hammond® board. The present invention can be used to download or upload files to or from applications running on the FPGA. In use, the present invention is useful for downloading and uploading files or information to or from the FPGA, and enabling bi-directional data through a tri-state data bus on the parallel port.

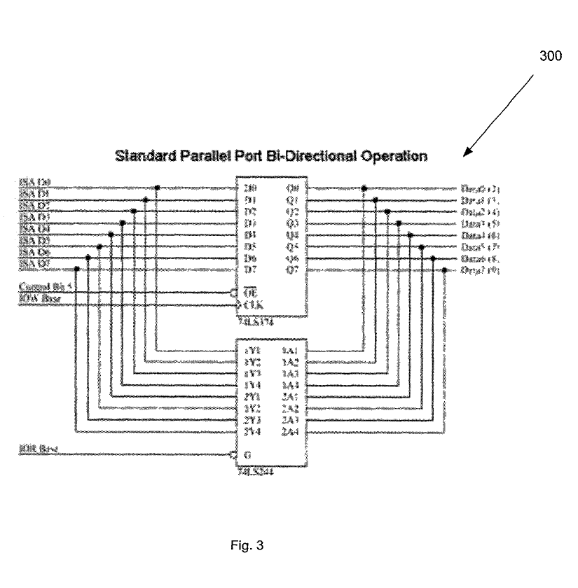

FIG. 7 illustrates the format 700 of each port, in accordance with one embodiment of the present invention. The host side of the parallel port consists of three smaller ports, each one byte in length. The addresses of the status ports 702 and control ports 704 are one byte and two bytes respectively greater than the address of the parallel port, all direct accessing of these ports may be accomplished in any desired manner. For example, files “winNTpar.h” and “win95par.h” are used in the context of the C-programming language by the host program, to aid connection to the parallel port. Note Appendix A.

Of those shown in FIG. 7, the Select, Select_In and nError are useful when configuring the FPGA, as they cannot be reprogrammed as input/output data_bus pins. In addition to this, nlRQ, nIRQ_En pins are not necessarily connected to the FPGA, and the Direction pin controls the direction of the Data port from the Host end.

Although the data lines are bi-directional, trying to write to them by both the FPGA and the host will cause bus contention and possibly damage the pins. In the context of Handel-C, a pair of files “ParallelProtocol.h” and “HostPar.c” may optionally be written to use the Direction pin on the parallel port and the write_enable variable (linked to the tri-state data lines) in the FPGA to ensure that bus contention does not occur.

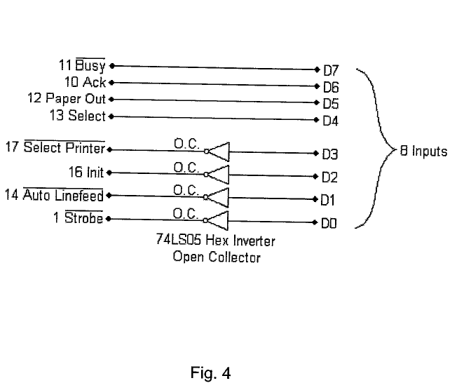

FIG. 8 illustrates the signals 800 into which the pins 802 are translated, in accordance with one embodiment of the present invention. The communications protocol relies on the status (input) and control (output) lines on the parallel port. The pins are translated into the signals, as shown in FIG. 8.

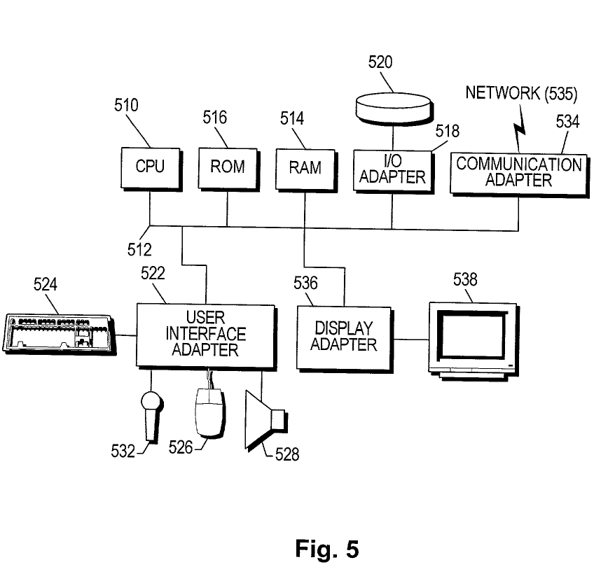

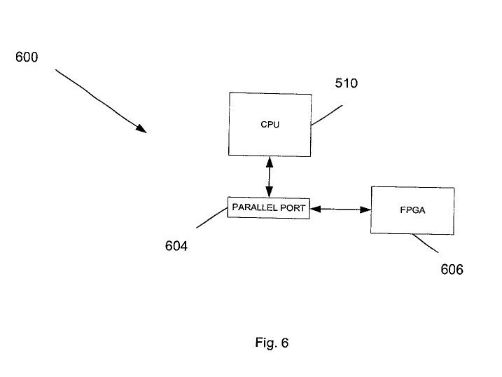

FIG. 9 illustrates a protocol 900 used for each byte sent to the FPGA. Once a signal has been received by the FPGA, this signal is acknowledged before the host sends anything else. It is initiated by the FPGA setting ACK high, indicating that it wishes to receive a file. Note operation 902. At this, the host sets READY_TO_SEND high in operation 904 at the beginning of the file, and sets it low at the end of the file to tell the FPGA that the data transfer is complete. Note operation 906.

FIG. 9A is a timing diagram illustrating the timing associated with the protocol 900 of FIG. 9. With respect to timing, the host sends a two (2) byte data buffer.

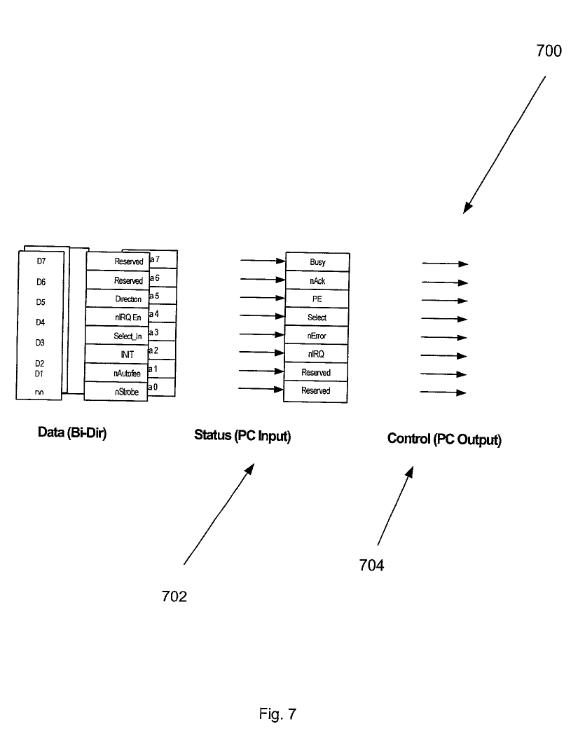

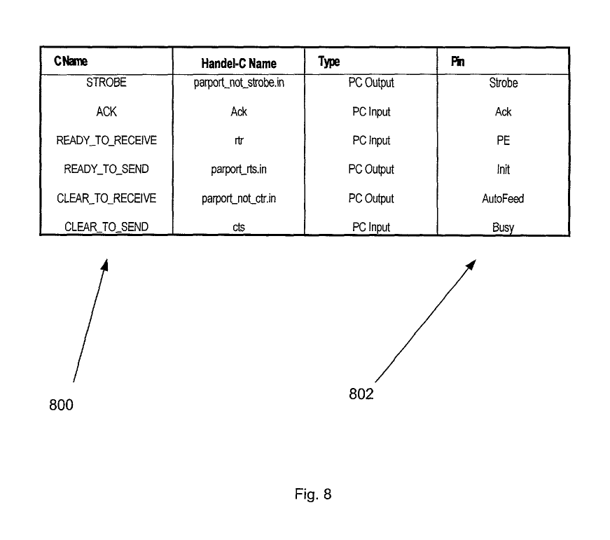

FIG. 10 shows the protocol 1000 associated with the host, in accordance with one embodiment of the present invention. As shown, the host receiving each byte of data is similar to the protocol set forth hereinabove during reference to FIG. 9. This is initiated by the FPGA setting CLEAR_TO_SEND high in operation 1002 at the beginning of a data buffer, and resetting it low to indicate that the buffer has been sent. FIG. 11 is a timing diagram showing the timing 1100 associated with the operation of the protocol 1000 of FIG. 10.

Interface Declarations

In the aforementioned file “ParallelProtocol.h,” the status pins may be declared using the bus_out declaration. All the control pins may be declared using bus_clock_in, to ensure that the value of the input lines is clocked continuously.

The “init protocol” Macro

This macro may be designed to wait until the host has lowered the parport_rts.in (READY_TO_SEND) signal. The pull-up resistor in the parallel port sets all the pins high if there is nothing flowing through them. Pulling the parport_rts.in pin down indicates to the FPGA that the host program is running. This macro may precede any other parallel port related macros. It takes no arguments.

The “send” Macro

This contains the Handel-C protocol for sending a data buffer to the host program. It may be called once, every time a data buffer needs to be sent. The send macro takes two arguments, data_buffer, a RAM containing the data to be sent, and buffer_length, the length of this buffer in bytes. Before commencing with the actual protocol, the status of parport_rts.in may be checked. If this is high, some data is currently being received, so the FPGA may wait until this is finished before a send can take place, (otherwise this would cause bus contention).

The FPGA raises cts and continues with the protocol described above. Once per iteration, the variable buf_index, an index to the data_buffer ram, is incremented to send the next byte of data. When buf_index reaches buffer_length, cts is lowered to tell the host that the entire buffer has been sent. After resetting buf_index, and buffer_length, the macro terminates until it is called again with the next data buffer.

The “receive” Macro

This contains the Handel-C protocol for receiving data from the host program and should be called by the FPGA every time it wants to receive a data file or buffer. The receive macro takes one argument, data_channel, which receives the data, a byte at a time. This macro may be run in parallel with another macro which takes the data off the channel as it is received, and makes use of it. Before the receive protocol commences, the value of cts is checked. If cts is high, a send is in progress so the FPGA may wait before a receive can take place (to avoid bus contention).

The FPGA raises ack to tell the host that it wishes to receive a file and the protocol continues as described above, writing the data to the channel. After each iteration, the FPGA checks that parport_not_strobe.in is raised to indicate that another byte will be sent. If parport_not_strobe.in is not raised, the FPGA program checks the value of parport_rts.in, which indicates the end of the data buffer. Finally, ack is lowered.

Host C Operations

The host code consists of one function HostProtocol, which may be called from a main program function. Before any data transfer, a file out.txt is created to store all the data received from the FPGA, and the parallel port is opened (by calling open_port( ) from either win95par.h or winNTpar.h). The host then sends the FPGA a signal that it is running, by setting READY_TO_SEND low, and enters the main while loop.

The loop is split into two parts, one for receiving and one for sending data. If CLEAR_TO_SEND is set high, the FPGA is requesting that the host receives some data, and the host receive protocol continues as described above, saving the received data, byte by byte into out.txt. If CLEAR_TO_SEND is not high, the host program is either idle or sending data; the second half of the while loop is executed, and the host checks the value of ACK. If ACK (which is inverted) is low, the FPGA is requesting that the host sends some data.

The send code requires three variables, *len[ ], which stores the lengths of the n files, FileNum, the current data file being sent, and counter, an index into the current data file. As each iteration of the send protocol executes, counter is incremented until the whole of file argv[ FileNum +2 ] is sent. On completion, READY_TO_SEND is set low to signal to the FPGA that the file has been downloaded, and FileNum is incremented ready for the next file download.

If the host is neither sending nor receiving, READY_TO_SEND is kept low, and the program waits for a send or receive request.

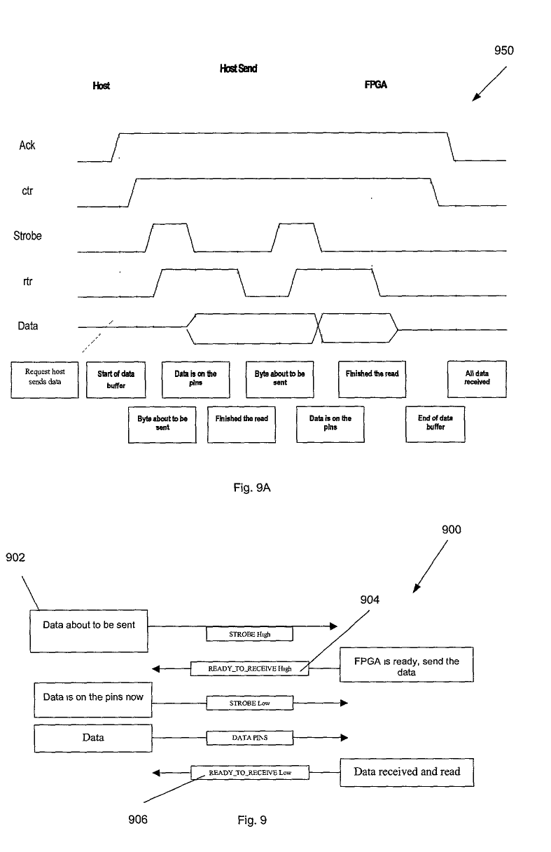

FIG. 12 illustrates FPGA and Host code 1200, external files 1202, external programs 1204, additional files 1206 that make up the present invention, macros 1208, and additional functions 1210 written in C.

The external files 1202 may be included in any program wishing to make use of procedures set forth hereinabove. The external programs 1204 are those upon which the present invention may depend. The additional files 1206 are those that make up the present invention. As shown, such additional files are split into two sections: Handel-C files and host CIC++/VC++ files.

The macros 1208 are defined in the Handel-C code. They are all external macros, and can be called from other procedures or applications. The functions 1210 are defined by C code. They are all external functions and may be called from another function. Note Appendix A.

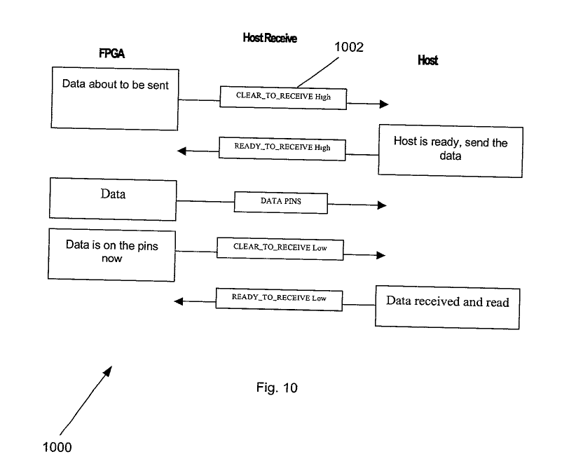

FIG. 13 illustrates a method 1300 for providing communication between a gate array and a host. The process begins with the receipt of a request to execute an operation on a gate array coupled to a host. Note operation 1302. Initially, in operation 1304, a type of the gate array is identified. Thereafter, in operation 1306, it is determined whether the gate array is capable of the operation based on the type thereof. Further, the operation is conditionally executed on the gate array based on the previous step. See operation 1308.

The present invention groups together a plurality of download and send programs for existing FPGA boards. In addition, the program offers the additional functionality of send/receive to and from boards including, but not limited to the Blizzard® and Xess®

XSV boards. The present invention also downloads to the Xess® XSV board and checks for the capabilities and version number of the current CPLD code. The download code can also be built for either Windows® NT or Windows® 95/98.

In operation, the present invention automatically detects which board is connected, and is capable of downloading to a plurality of boards including, but not limited to Blizzard®, Hammond® and Xess® XSV boards. Further, it is capable of sending/receiving data to and from programs running on the various boards, and checking for the version and capabilities of the current CPLD code.

The instant application program is thus able to identify a board type and CPLD code capabilities from the identification number sent by the CPLD during initialization stages. This is required because some CPLD's are not large enough to contain the code required for all operations.

For all operations, the program begins by checking the parameters ensuring that the requested procedure is compatible with the target device capabilities.

The send/receive protocol (from the host end) for all other boards may include Hammond® protocol except that different pins are used, to avoid multiple usage of pins within the CPLD. First the start status command (of Ox8) is sent to the CPLD to initialize the send/receive state. After waiting for an acknowledgement from the CPLD (FRTC low), the HCC (Host Channel Control) pin is strobed to tell the FPGA that the host has received the acknowledgement and is entering the protocol stage.

This protocol is a handshaking system based around four pins: HCC, HDC (Host Data Control), FCC (FPGA Channel Control) and FDC (FPGA Data Control). The Data is routed straight through the CPLD to the running FPGA. In Windows® NT, this handshaking may be done within a Genport® driver to aid speed. At any time, if FRTC

(FPGA Ready To Communicate) goes high, this is taken a quit signal from the FPGA and the protocol is terminated.

Configuration download is performed in the same manner, using different initialization codes. After all configuration data has been sent the host checks the INIT pin; if this is low the FPGA aborted and was not programmed correctly. In Windows® NT, this is done using the buffered method within a Genport® driver. Flash memory download has a slightly different format. Prior to the data write, the blocks to be written in the flash are erased by sending the address and an erase status command to the CPLD.

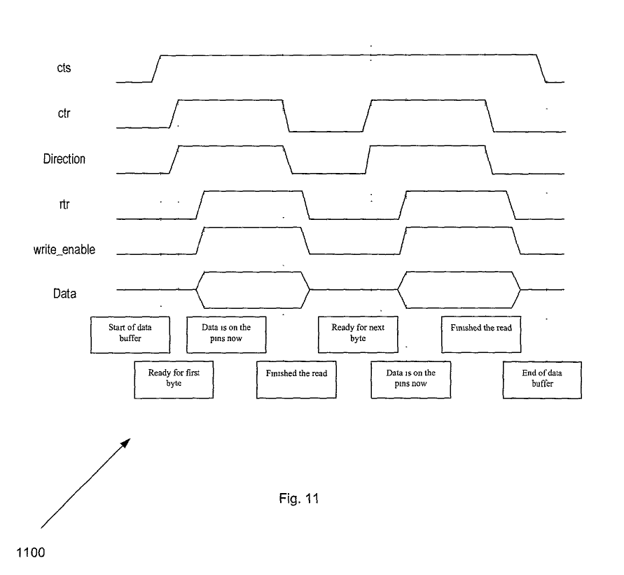

FIG. 14 is a flowchart illustrating the method 1400 with which the flash block address and a byte of data are sent to the flash. The host sets the address pins to zero and reads back to test the data in the address just written. This whole process is followed by another test which verifies that the data has been written correctly.

The program may be executed from the command prompt in the manner shown in Table 10.

TABLE 10

gdNT <command opts> <file>
<address opts> <port> <other opts>

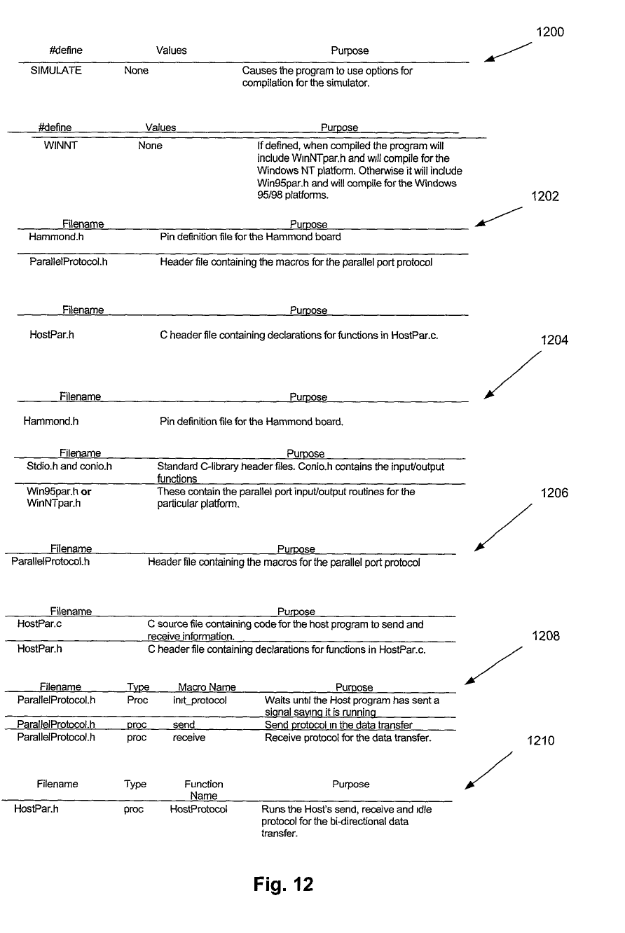

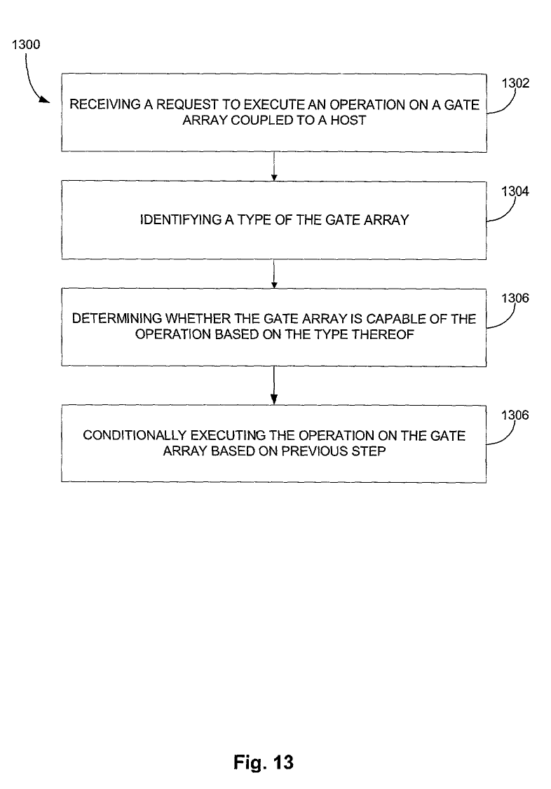

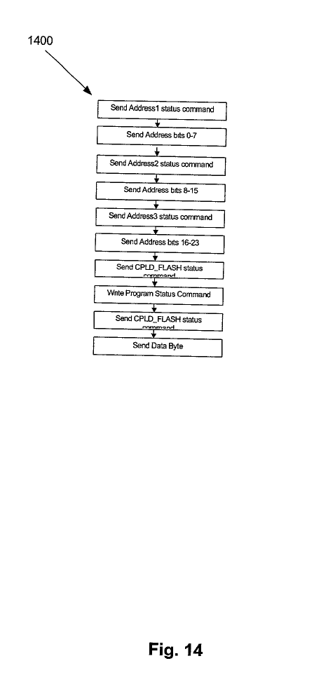

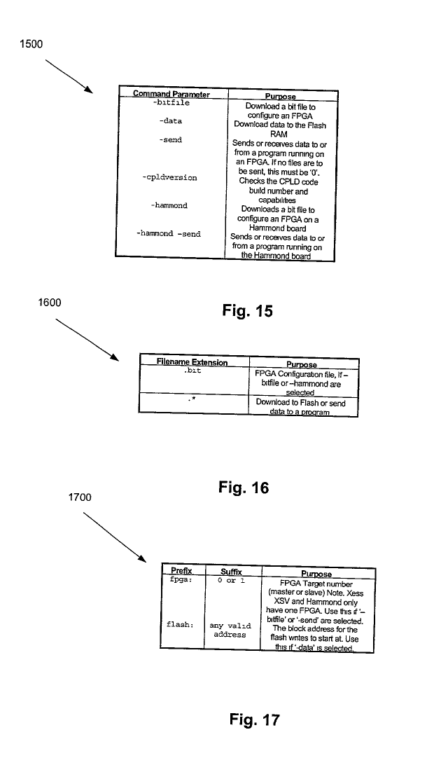

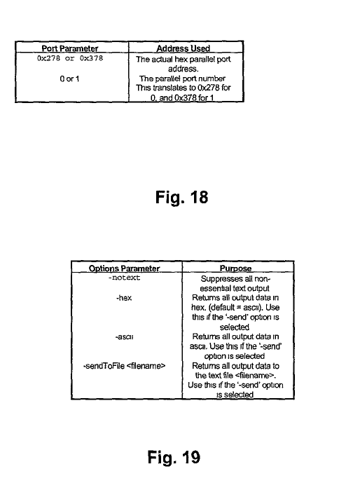

FIG. 15 illustrates various options 1500 for use as the command options parameter shown in Table 1. FIG. 16 illustrates various options 1600 for use as the final name parameter shown in Table 1. FIG. 17 illustrates various options 1700 for use as the address options parameter shown in Table 1. The address options may not be needed if the target device is a Hammond® board. FIG. 18 illustrates various options for use as the port parameter shown in Table 1. The port parameter is not needed if one is downloading from Windows® NT as the Genport® driver pre-specifies the address to 0×378, LPT: 1. If used, this may be the fourth parameter. FIG. 19 illustrates various options for use as the “other” options parameter shown in Table 1. These parameters can be used in any order (so long as ‘sendToFile’ is followed by <filename>).

Tables 11-15 illustrate various examples of the foregoing concepts. Table 11 illustrates a command that may be used to configure FPGA #0 on Blizzard/Xess® boards:

TABLE 11

gdNt -bit <filename> fpga:0

Table 12 illustrates a command that may be used to send to FPGA #0 on the Blizzard/Xess® boards and receive data to a text file.

TABLE 12

gdNt -bit <outfile> fpga:0 -sendToFile <infile>

Table 13 illustrates a command that may be used to write to the Flash (address 800000).

TABLE 13

gdNt -data <filename> flash:800000

Table 14 illustrates a command that may be used to configure a Hammond® board.

TABLE 14

gdNt -hammond <filename>

Table 15 illustrates a command that may be used to send to the Hammond® board and receive data to the command prompt in hex.

TABLE 15

gdNt -Hammond -send <outfile> -hex

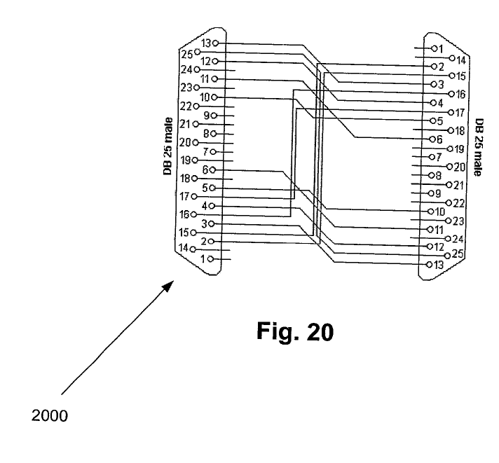

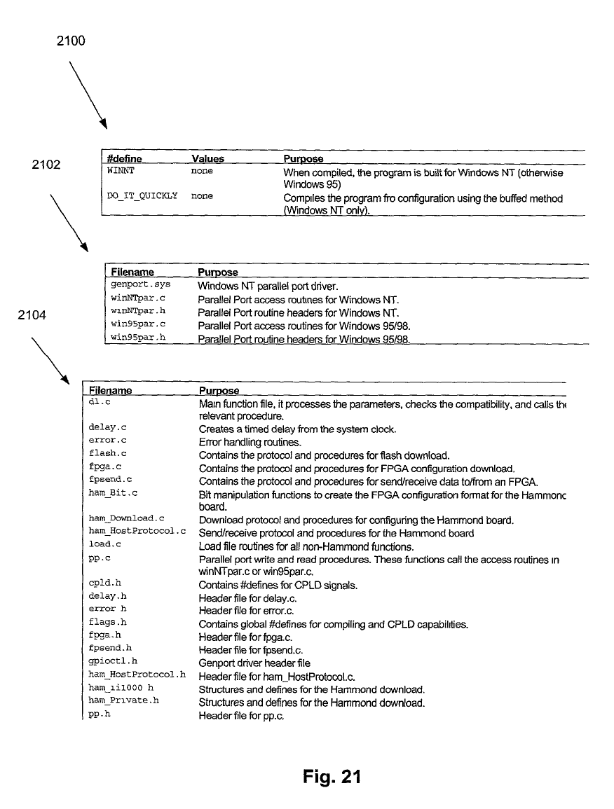

The present invention preferably requires that the parallel port be set up (in BIOS) as SPP (Standard Parallel Port) with address 0×378. FIG. 20 illustrates a preferred embodiment of a parallel port cable 2000 to be used in conjunction with the present invention. FIG. 21 illustrates various definitions 2100, external dependencies 2102, and program files 2104 associated with the present invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for providing communication between a gate array and a host, comprising the steps of:
(a) receiving a request to execute an operation on a gate array coupled to a host;
(b) identifying a type of the gate array;
(c) determining whether the gate array is capable of the operation based on the type thereof; and
(d) conditionally executing the operation on the gate array based on step (c).

2. A method as recited in claim 1, wherein the type of the gate array is identified by receiving an identifier from the gate array.

3. A method as recited in claim 2, wherein the identifier is received during an initialization stage.

4. A method as recited in claim 1, wherein the gate array is programmed utilizing Handel-C.

5. A method as recited in claim 1, wherein the step of determining includes comparing parameters corresponding to the operation with capabilities associated with the type of the gate array.

6. A computer program product for providing communication between a gate array and a host, comprising:
(a) computer code for receiving a request to execute an operation on a gate array coupled to a host;
(b) computer code for identifying a type of the gate array;
(c) computer code for determining whether the gate array is capable of the operation based on the type thereof, and
(d) computer code for conditionally executing the operation on the gate array based on computer code segment (c).

7. A computer program product as recited in claim 6, wherein the type of the gate array is identified by receiving an identifier from the gate array.

8. A computer program product as recited in claim 7, wherein the identifier is received during an initialization stage.

9. A computer program product as recited in claim 6, wherein the gate array is programmed utilizing Handel-C.

10. A computer program product as recited in claim 6, wherein the computer code for determining includes comparing parameters corresponding to the operation with capabilities associated with the type of the gate array.

11. A system for providing communication between a gate array and a host, comprising:
(a) logic for receiving a request to execute an operation on a gate array coupled to a host;
(b) logic for identifying a type of the gate array;
(c) logic for determining whether the gate array is capable of the operation based on the type thereof; and
(d) logic for conditionally executing the operation on the gate array based on logic segment (c).

12. A system as recited in claim 11, wherein the type of the gate array is identified by receiving an identifier from the gate array.

13. A system as recited in claim 12, wherein the identifier is received during an initialization stage.

14. A system as recited in claim 11, wherein the gate array is programmed utilizing Handel-C.

15. A system as recited in claim 11, wherein the logic for determining includes comparing parameters corresponding to the operation with capabilities associated with the type of the gate array.
